(19) United States
(12) Patent Application Publication
(10) Pub. No.: US 2008/0071649 A1
(43) Pub. Date: Mar. 20, 2008

(54) METHOD AND SYSTEM OF MANAGING ON-THE-SHELF RETAIL INVENTORIES

(75) Inventors: Robert J. Dunst JR., Castro Valley, CA (US); Jonathan G. Zakaras, Dublin, CA (US); Steven Arthur Burd, Alamo, CA (US); Kelly Paul Griffith, Snoqualmie, WA (US)

Correspondence Address: PILLSBURY WINTHROP SHAW PITTMAN LLP, P.O. BOX 10500, MCLEAN, VA, 22102, US

(73) Assignee: SAFEWAY INC., Pleasanton, CA (US)

(21) Appl. No.: 11/946,027

(22) Filed: Nov. 27, 2007

Related U.S. Application Data
(63) Continuation of application No. 09/904,780, filed on Jul. 13, 2001.

(51) Int. Cl. G06Q 10/00; G06F 17/00

(52) U.S. Cl. 705/28

(57) ABSTRACT

On-the-shelf retail inventories are managed by periodically processing point-of-sale data to determine the number of units that have been sold during a specified period, and comparing the number of units that have been sold to a historical value. An alert is issued to a store when the difference between the comparison indicates that certain items are not selling at the expected rate.

### CROSS-REFERENCE TO RELATED APPLICATION

The present application is a continuation of copending U.S. patent application Ser. No. 09/904,780, filed Jul. 13, 2001, entitled “METHOD AND SYSTEM OF MANAGING ON-THE-SHELF RETAIL INVENTORIES,” the disclosure of which is hereby incorporated herein by reference in its entirety and for all purposes.

### BACKGROUND OF THE INVENTION

1. Field of the Invention

The present invention relates to inventory management and, more particularly, to a method and system of managing on-the-shelf retail inventories.

2. Description of the Related Art

One of the challenges of a retail store that sells thousands of different items, such as a grocery store, is to insure that items that are available for sale can be found and purchased by the customers. There are a variety of reasons why a customer who wants to buy an item will not buy the item even though the item is available and the price is within the range of what the customer expects to pay.

For example, a customer may not buy an item if only one or two of the items remain on the shelf and the items are pushed to the back of the shelf. Customers may also not buy when the sign or tag for the item is missing or otherwise unable to convey the price or any other essential information regarding the item.

Further, when items are block by temporary displays, customers frequently can not find the item, or are unwilling to move the displays to gain access to the item. In addition, a customer can not buy the item, even though there may be a stock of the item in the warehouse area of the store, when the shelf that holds the item is empty.

Although managers and other in-store personnel know to “walk-the-aisles” and look for out-of-stock and other sales conditions, there is often little time to perform these tasks during busy periods when customer-service needs are greatest. Thus, there is a need for a method and system of managing these on-the-shelf conditions to identify and remedy the underlying problem so that a customer is more likely to find and purchase an item they are seeking to buy.

### SUMMARY OF THE INVENTION

The present invention provides a method and system of managing on-the-shelf retail inventories to identify specific problem areas within the store. The problem areas are conveyed to in-store personnel who, because specific problem areas are identified, can respond to the problem areas even during busy periods.

The method of the present invention utilizes a current reporting period table that has a number of rows, a number of columns, and a number of fields. Each field, in turn, has an initial value. The method of the present invention includes the step of collecting a plurality of transaction data blocks.

The method also includes the step of constructing a temporary table having a plurality of fields that correspond with the fields in the current reporting period table, and processing the plurality of transaction data blocks to determine a calculated value for each field in the temporary table.

The method further includes the step of adding the calculated value for each field in the temporary table to an existing value in each corresponding field in the current reporting period table. The method additionally includes the step of determining, for each item in the current reporting period table, if an alert condition exists, and issuing an alert when an alert condition exists.

The system of the present invention includes a computer that has means for collecting a plurality of transaction data blocks. The computer has also means for constructing a temporary table having a plurality of fields that correspond with the fields in the current reporting period table, and processing the plurality of transaction data blocks to determine a calculated value for each field in the temporary table.

The computer further has means for adding the calculated value for each field in the temporary table to an existing value in each corresponding field in the current reporting period table. The computer additionally has means for determining, for each item in the current reporting period table, if an alert condition exists, and issuing an alert when an alert condition exists.

A better understanding of the features and advantages of the present invention will be obtained by reference to the following detailed description and accompanying drawings that set forth an illustrative embodiment in which the principles of the invention are utilized.

### BRIEF DESCRIPTION OF THE DRAWINGS

FIG. 1 is a block-diagram illustrating an on-the-shelf inventory management system 100 in accordance with the present invention.

FIG. 2 is a flow chart illustrating a method 200 of measuring on-the-shelf inventory conditions in accordance with the present invention.

FIG. 3 is a flow chart illustrating a method 300 of implementing step 224 in accordance with the present invention.

FIG. 4 is a flow chart illustrating a method 400 of issuing an alert in accordance with the present invention.

FIG. 5 is a flow chart illustrating a method 500 of receiving a response to an alert in accordance with the present invention.

FIG. 6 is a flow chart illustrating a method 600 of responding to the alert in accordance with the present invention.

### DETAILED DESCRIPTION

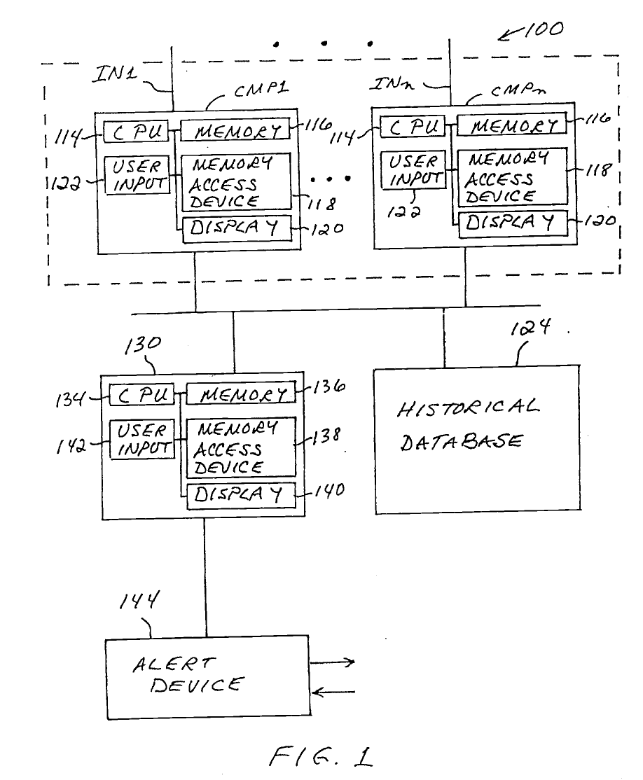

FIG. 1 shows a block-diagram that illustrates an on-the-shelf inventory management system 100 in accordance with the present invention. As shown in FIG. 1, system 100 includes a data collector 110 that collects transaction data blocks from a number of input data streams IN1-INn. The transaction data blocks include point-of-sale information from a number of store locations.

As further shown in FIG. 1, data collector 110 includes a number of input computers CMP1-CMPn. Each input computer CMP, in turn, has a central processing unit (CPU) 114 and a memory 116 that is connected to CPU 114. Each memory 116 stores an operating system and program instructions, and temporarily stores a number of transaction data blocks.

Each memory 116 can be implemented with a number of memory elements, such as volatile and non-volatile memory elements. Each memory 116 is also implemented with a dual control system so that data can be written into one part of memory 116 while data is simultaneously being read out of another part of memory 116.

Each input computer CMP also has a memory access device 118, such as a disk drive or a networking card, which is connected to CPU 114 and memory 116. Each memory access device 118 allows the program instructions to be transferred to a corresponding memory 116 from an external medium, such as a disk or a networked computer. In addition, device 118 allows transaction data blocks in the corresponding memory 116 to be transferred to the external medium.

In addition, each input computer CMP further has a display 120 that is connected to CPU 114. Display 120 displays images to the user which are necessary for the user to interact with the program. Further, each input computer CMP additionally has a user-input device 122, such as a keyboard and a pointing device, which is connected to CPU 114. The user operates input device 122 to interact with the program.

In operation, the input computers CMP1-CMPn each run a program that receives transaction data blocks from an input data stream IN, and stores the transaction data blocks in its memory 116. Each transaction data block identifies, for example, a single item that was purchased, the department of the item, the store where the item was purchased, the price that was paid for the item, and the time the item was purchased. A transaction data block can also include other information relevant to the purchased item.

As further shown in FIG. 1, system 100 also includes a historical database 124 that includes historical point-of-sale information for a number of store locations. Specifically, given an item, a department, a store location, an indicated time period, and a day, database 124 can output a statistical measure of the number of items that are sold during that time period on that day for that store. For example, given item 12, department 22, store 56, and midnight to 11:45 a.m. on a Tuesday, database 124 could indicate that the median number of items that are sold during that time period on that day is 38.

System 100 additionally includes an inventory management computer 130 that is connected to computers CMP1-CMPn and database 124. Computer 130 includes a central processing unit (CPU) 134, and a memory 136 that is connected to CPU 134. Memory 136 stores an operating system, program instructions, transaction data blocks, a current reporting table, a temporary table, and the values of one or more variables.

Memory 136 can also be implemented with a number of memory elements, such as volatile and non-volatile memory elements. Memory 136 can further be implemented with a dual control system so that data can be written into or read from one part of memory 136 while data is simultaneously being read out of or written to another part of memory 136.

Computer 130 also has a memory access device 138, such as a disk drive or a networking card, which is connected to CPU 134 and memory 136. Memory access device 138 allows the program instructions to be transferred to memory 136 from an external medium, such as a disk or a networked computer. In addition, device 138 allows data in memory 136 to be transferred to the external medium.

In addition, computer 130 further has a display system 140 that is connected to CPU 134. Display system 140 displays images to the user which are necessary for the user to interact with the program. Further, computer 130 additionally has a user-input device 142, such as a keyboard and a pointing device, which is connected to CPU 134. The user operates input device 142 to interact with the program.

As further shown in FIG. 1, system 100 additionally includes an alert device 144 that is connected to computer 130. Alert device 144, which includes a computer, a memory, and an alert-type register, processes alert commands, issues alerts to stores, and receives responses from the stores. The memory in alert device 144 maintains an alert log and a blocked log.

An alert log is a table that stores information about each alert that has been issued. The alert log table, for example, can have a row for each alert that was issued, and a number of fields in each row. The fields can include an item number, a department number, a store number, a time measure of when the alert was issued, a response received indicator, and a time measure of when the response was received. (Other fields can also be included.)

The alert log can be used as a data source for management tools that can be configured to collect, analyze, and present operational data to management, such as to identify stores which fail to respond to a number of alerts. This, in turn, allows defective and inadvertently turned-off devices (that receive the alert signal) to be readily identified.

The blocked log is a list of the items, such as out-of-stock items, that can not be corrected within a short period of time. The blocked log is used to identify an item in a department of a store, and a blackout period. The blackout period is the expected time that is required to correct the problem.

For example, when an item is out-of-stock and the next delivery is four hours later, the blocked log prevents an alert from being issued for that item during the next four-hour period. As a result, the blocked log prevents the manager or other in-store personnel from being continuously alerted when it is already known that the situation can not be corrected in a short period.

The blocked log can also be used as a data source for management tools that can be configured to collect, analyze, and present operational data to management, such as the frequency of out-of-stock conditions. This, in turn, allows poor distribution or ordering systems to be readily identified.

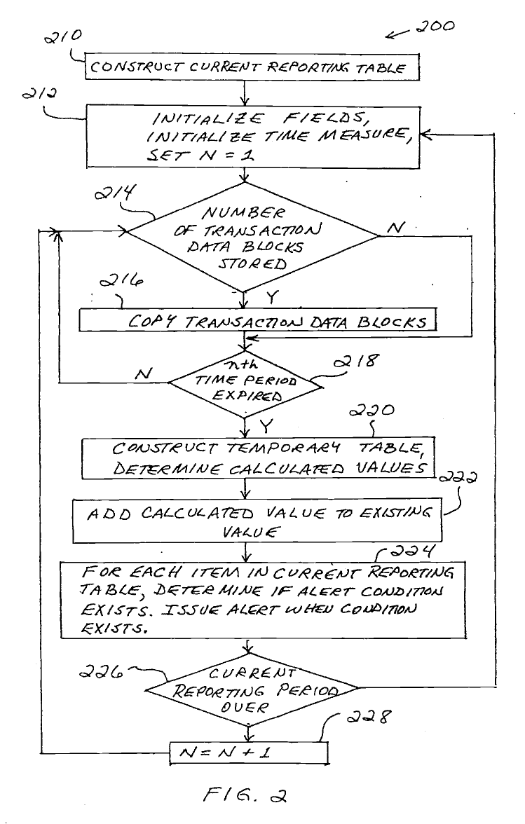

FIG. 2 shows a flow chart that illustrates a method 200 of measuring on-the-shelf inventory conditions in accordance with the present invention. Method 200 is implemented in software that is programmed into computer 130. As shown in FIG. 2, method 200 begins at step 210 by constructing a current reporting period table that has a number of rows and a number of columns.

The current reporting period table is formed to have rows for a number of items in a number of departments in a number of stores such that each row of the current reporting period table represents an item within a department of a store. Each column of the table represents an attribute of an item, such as the number of units that have been sold since the current reporting period began. Other examples of attributes include a number of sales and accounting related attributes. The current reporting period table is stored in memory 136.

Once method 200 has constructed the current reporting period table, method 200 moves to step 212 to initialize the fields (where a row and a column intersect) in the table to an initial value. For example, the field in each row that represents the number of units that have been sold since the current reporting period began can be set to an initial value of zero. Method 200 also initializes a time measure in step 212, and sets the value of a variable n to one. The initialization of the time measure can be implemented in a number of ways such as by recording a time stamp.

Next, method 200 moves to step 214 to determine if a memory 116 in one of the input computers CMP1-CMPn has received a predefined number of transaction data blocks, such as 5,000 data blocks. When a memory 116 has received a predefined number of transaction data blocks, method 200 moves to step 216 to copy the transaction data blocks from memory 116 (that received the predefined number of data blocks) into memory 136.

Next, method 200 moves to step 218 to determine if an nth time period has expired. Method 200 determines if the nth period has expired by multiplying a base time, such as 15 minutes, times the value of the variable n and then adding the total to the initial time measure. For example, if a time stamp is utilized, method 200 determines if the current time stamp is equal to or greater than the initial time stamp plus the nth time period (15 minutes in the example—the base time times n). Method 200 also moves to step 218 from step 214 when the predefined number of transaction data blocks has not been stored in a memory 116 in one of the computers CMP1-CMPn.

If the predefined time has not expired, method 200 moves back to step 214 to repeat the process. Thus, method 200 continues to loop, copying transaction data blocks into memory 136 each time the predefined number of blocks is stored in a memory 116 in one of the input computers CMP1-CMPn until the nth time period has expired. As a result, at the end of the first time period, memory 136 holds, for example, 15 minutes worth of point-of-sale data from a number of stores.

When the predefined time expires, method 200 moves to step 220 to construct a temporary table in memory 136 that corresponds with the current reporting period table. Method 200 processes the transaction data blocks to determine a calculated value for each field in the temporary table.

Method 200 can process the data blocks in the temporary table by, for example, grouping together all of the point-of-sale records for an item in a department of a store, and then counting the number of records to determine how many units of the item have been sold. In this case, method 200 could determine from the transaction data blocks in memory 136 that store 1 has sold 5 units of item 1 of department 1, while store 2 has sold 15 units of item 1 of department 1.

Next, method 200 moves to step 222 to add each calculated value in a field in the temporary table to the existing value in the corresponding field in the current reporting period table. For example, if method 200 determined that store 1 had sold 5 units of item 1 of department 1, then the field that represents this item in the current reporting period table is incremented by 5.

As described in greater detail below, method 200 loops until the current reporting period is over. As a result, the current reporting period table of the present invention has data that has a maximum staleness equal to the duration of the current reporting period. Thus, the current reporting period table can be used as a data source for management tools that can be configured to collect, analyze, and present near real-time sales data to management.

The near real-time presentation of data allows management the ability to identify slow moving items closer to the deadline for placing advertisements. This, in turn, provides a more focused advertising effort. In addition, items with a lot of demand in one store and little or no demand in another store can be more quickly identified, thereby more readily allowing stock to be shifted between stores to take advantage of the greater demand.

Returning to FIG. 2, method 200 next moves to step 224 to determine, for each item in the current reporting period table, if an alert condition exists. If an alert condition exists, method 200 issues an alert. Method 200 next moves to step 226 to determine if the current reporting period is over. For example, a new reporting period could begin every 24 hours. Thus, method 200 could determine if the current reporting period is over by adding a new reporting period value, such as 24 hours, to the initial time stamp to define a threshold value, and then determine if the current time stamp is equal to or greater than the threshold value.

If the current reporting period is not over, method 200 moves to step 228 to increment the value of the variable n, and then returns to step 214 and continues to loop until the original reporting period has been completed. On the other hand, if it is time to begin a new reporting period, method 200 returns to step 212.

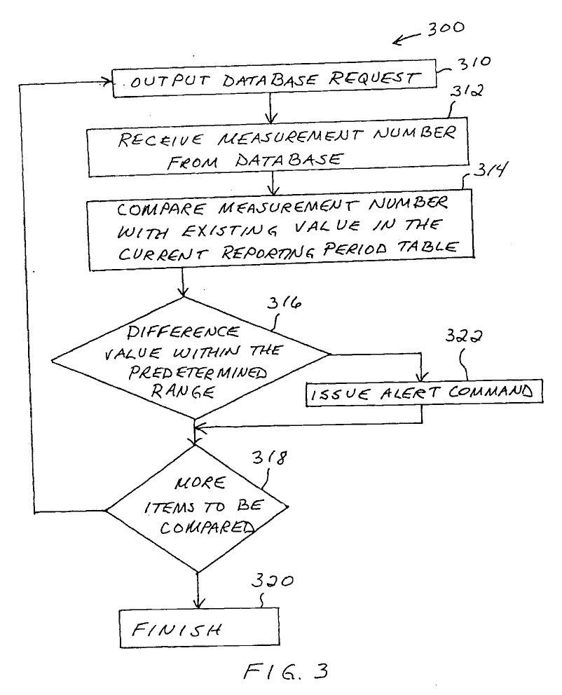

FIG. 3 shows a flow chart that illustrates a method 300 of implementing step 224 in accordance with the present invention. As shown in FIG. 3, method 300 begins at step 310 by outputting a database request to historical database 124. Each database request identifies an item (such as item 1) in a department (such as department 1) of a store (such as store 1) from the initial time measure to a value defined by adding the nth time period to the initial time measure on a specified day.

Method 300 then moves to step 312 to receive from historical database 124a measurement number that represents a statistical measure of the number of units that have been sold since the beginning of the current reporting period. For example, database 124 could output that the median number of units of item 1 of department 1 of store 1 that are sold from midnight to 10:00 a.m. on a Monday is 22.

Method 300 then moves to step 314 to compare the measurement number output by database 124 with the existing value stored in the corresponding field of the current reporting period table to determine a difference value. Thus, the difference value indicates whether, for example, fewer units of the item have been sold than the median number of units sold during this time period and day.

After this, method 300 moves to step 316 to determine if the difference value is within a predetermined acceptance range. The predetermined acceptance range can be defined by, for example, a statistical measure or other set of rules. If the difference value is within the predetermined acceptance range, then method 300 moves to step 318 to determine if there are more items in the current reporting period table that remain to be compared with a measurement value output by database 124. When more items remain to be compared, method 300 returns to step 310 to repeat the steps. When there are no more items to be compared, method 300 moves to step 320 to finish.

On the other hand, if the difference value in step 316 is outside of the predetermined range, then method 300 moves to step 322 where computer 130 commands alert device 144 to issue an alert. The alert command identifies the item, the department, and the store that caused to alert command to be generated.

Once the alert command has been issued to alert device 144, method 300 moves to step 318 to determine if there are more items that remain to be compared. Method 300 then moves to step 310 to repeat the steps, or to step 320 to finish, depending on whether there are more items to be compared.

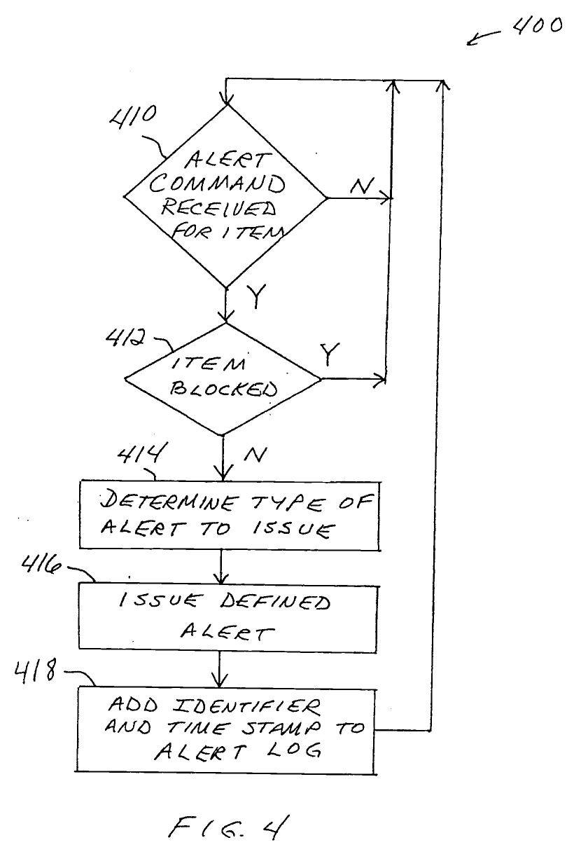

FIG. 4 shows a flow chart that illustrates a method 400 of issuing an alert in accordance with the present invention. Method 400 is implemented in software that is programmed into the computer in alert device 144. As shown in FIG. 4, method 400 begins at step 410 by determining if an alert command has been received. Once an alert command has been received, method 400 moves to step 412 to determine if the item identified by the alert command has been blocked. As described in greater detail below, the alert command can be blocked for a number of reasons.

When the alert command is not blocked, method 400 moves to step 414 to determine what type of alert is to be issued. The alert can be issued, for example, as a page, an e-mail, or a web page posting. When an alert is issued, the alert identifies an item in a department in store. The type of alert to be issued can be defined by setting the contents of the alert-type register in alert device 144. The alert-type register can be configured to output any combination of alerts, such as only a page, or as a page, an e-mail, and a web page posting.

Following this, method 400 moves to step 416 to issue an alert of the type defined by the alert-type register. Once the alert has been issued, method 400 moves to step 418 to add an identifier that identifies the alert and a time stamp to the alert log stored in alert device 144. Method 400 then returns to step 410.

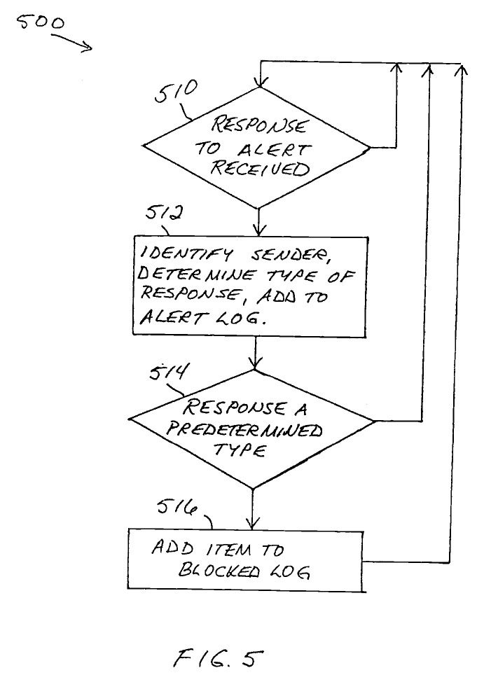

FIG. 5 shows a flow chart that illustrates a method 500 of receiving a response to an alert in accordance with the present invention. Method 500 is implemented in software that is programmed into the computer in alert device 144. As shown in FIG. 5, method 500 begins at step 510 by determining whether a response to an alert has been received.

When a response is received, method 500 moves to step 512 to identify the sender, determine the type of response, and add the information to the alert log. The type of response can indicate, for example, an out-of-stock condition, a missing sign condition, a blocked shelf condition, a product-to-the-back-of-the-shelf condition, as well as other conditions.

Method 500 then moves to step 514 to determine if the type of response is a predetermined type of response. When the response is not a predetermined response, method 500 returns to step 510. When the response is a predetermined response, such as an out-of-stock condition, method 500 moves to step 516 to add the item to the blocked log as a blocked item with a blackout period. Method 500 then returns to step 510.

As a result, the next time method 500 moves to step 412 (FIG. 4) in response to the item (in the department of the store), the alert will be blocked for the duration of the blackout period. Thus, when conditions exist that are not correctable by the manager or in-store personnel, the present invention prevents repeated alerts from being issued throughout the remainder of the current reporting period.

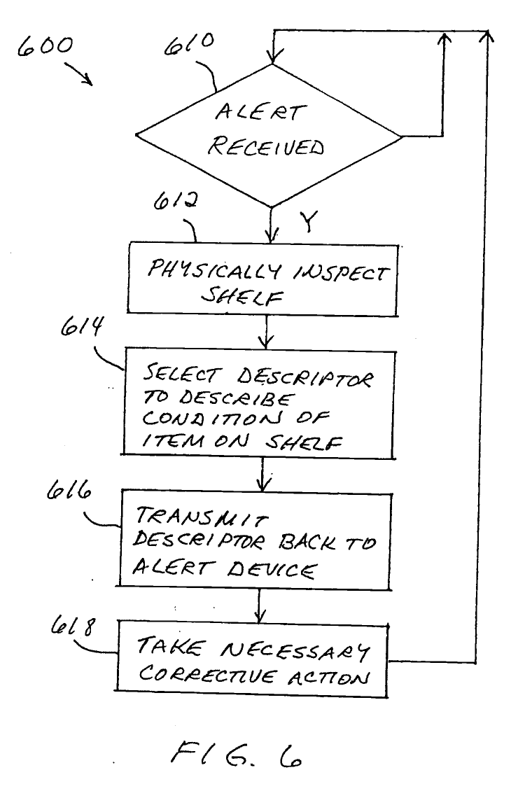

FIG. 6 shows a flow chart that illustrates a method 600 of responding to the alert in accordance with the present invention. As shown in FIG. 6, method 600 begins at step 610 by determining if an alert has been received. When an alert is received, method 600 moves to step 612 where the manager or other in-store personnel physically inspect the shelf space in the store where the item is displayed.

Method 600 then moves to step 614 where the manager or other in-store personnel select one of a number of descriptors to describe the condition of the item on the shelf space in the store. Method 600 then moves to step 616 to transmit the selected descriptor back to alert device 144.

The descriptors can include, for example, an out-of-stock condition, a missing sign condition, a blocked shelf condition, a product-to-the-back-of-the-shelf condition as well as other conditions. Once the selected descriptor has been transmitted, method 600 moves to step 618 where the manager or other in-store personnel take the necessary corrective action, such as by replacing a sign or restocking the shelf Method 600 then returns to step 610.

It should be understood that various alternatives to the embodiment of the invention described herein may be employed in practicing the invention. Thus, it is intended that the following claims define the scope of the invention and that methods and structures within the scope of these claims and their equivalents be covered thereby.

What is claimed is:

1. A method of operating an on-the-shelf inventory management system, the inventory management system comprising a processing system including a distributed memory and a plurality of data collection devices for collecting data from one or more store locations, the method comprising the steps of:
collecting a plurality of transaction data blocks from one or more of the data collection devices, the data blocks including point-of-sale information;
updating a table of transactional data in the memory based on certain of the data blocks, wherein the certain data blocks are associated with a reporting period; and
issuing an alert when information in the certain data blocks satisfies predetermined criteria, wherein the alert identifies an item and a store; and
receiving a response to the alert indicative of conditions of the identified item on shelf space in the identified store.

2. The method of claim 1 and further comprising the step of obtaining data associated with a series of reporting periods by iteratively repeating the steps of collecting, updating and issuing, wherein statistical information derived by analyzing the series is used to quantify certain of the predetermined criteria.

3. The method of claim 1 wherein the table includes a plurality of fields, each field characterizing aspects of one or more items for sale, and further comprising the steps of:
initializing each field in the table before the collecting step; and
when the current reporting period is over, returning to the initializing step.

4. The method of claim 3, wherein the step of collecting includes:
receiving data blocks from the data collection device when a selected number of data blocks are available; and
receiving any remaining data blocks from the data collection device at the conclusion of the reporting period.

5. The method of claim 1 wherein the step of issuing an alert includes:
obtaining one or more measurement numbers from information in the database;
comparing the one or more measurement numbers with existing values in the table to form difference values; and
issuing an alert command when the difference values do not fall within predetermined acceptance ranges.

6. The method of claim 5 wherein the step of issuing an alert further includes:
determining whether an alert command has been received;
when an alert command is received, determining whether the identified item has been added to a blocked log;
when the identified item has not been added to the blocked log, issuing the alert.

7. The method of claim 6 wherein the alert includes a page.

8. The method of claim 6 wherein the alert includes an e-mail.

9. The method of claim 6 and further comprising the step of adding an identifier and a time stamp to an alert log to record the alert.

10. The method of claim 9 and further comprising the steps of:
determining whether a response to the alert has been received;
when a response to the alert is received,
identifying the sender,
determining a type of response, and
adding a record to the alert log;
determining whether the response is of a predetermined type; and
when the response is of the predetermined type, adding the identified item to a blocked log.

11. The method of claim 10 wherein the predetermined type includes an out-of-stock condition.

12. The method of claim 10 and further comprising the steps of:
determining whether the alert has been received;
when the alert has been received, inspecting a shelf location that corresponds with the identified item;
selecting a descriptor to describe a condition of the shelf location;
transmit descriptor back to the alert device; and
taking necessary corrective action.

13. The method of claim 5 wherein the step of issuing an alert further includes:
adding the identified item to the blocked log when the alert command is received and the identified item has not been added to the blocked log.

14. The method of claim 1, wherein the response is a predetermined response and the conditions include out-of-stock conditions, missing sign conditions, blocked shelf conditions and product-to-the-back-of-the-shelf conditions.

15. The method of claim 1 and further comprising the steps of:
determining whether an alert has been received;
when an alert has been received, inspecting a shelf location that corresponds with the identified item;
selecting a descriptor to describe a condition of the shelf location;
transmitting the descriptor back to the alert device; and
taking necessary corrective action.

16. A method of operating an on-the-shelf inventory management system, the method comprising the steps of:
measuring a number of units of an item that has been sold;
generating an alert when the number of units of the item that has been sold falls below a statistical measure of a number of units that are expected to have been sold, wherein the alert identifies the item and an associated store;
determining whether an alert has been received;
when an alert has been received, inspecting a shelf location that corresponds with the item;
selecting a descriptor to describe a condition of the shelf location;
transmitting a descriptor back to the system.

17. The method of claim 16 and further comprising the step of taking necessary corrective action.

18. An on-the-shelf inventory management system, the system comprising an inventory management server and a plurality of data collection devices, the system providing a current reporting period table that has a number of rows, a number of columns, and a number of fields, each field having an initial value, the system comprising:
a computer having:
means for collecting a plurality of transaction data blocks;
means for constructing a temporary table having a plurality of fields that correspond with the current reporting period table, and processing the plurality of transaction data blocks to determine a calculated value for each field in the temporary table;
means for adding the calculated value for each field in the temporary table to an existing value in each corresponding field in the current reporting period table;
means for determining, for each item in the current reporting period table, if an alert condition exists, and issuing an alert when an alert condition and
means for receiving a response to the alert indicative of conditions of an item identified by the alert.

19. An on-the-shelf inventory management system, the system providing information associated with transactions in one or more retail stores, comprising:
a server for receiving transactional data related to the one or more retail stores, the server being adapted to maintain the data in a database;
a transaction processor for arranging the data into a plurality of fields and for accumulating data received in a selected time period and recording the accumulated data in a reporting table, wherein the reporting table is indexed by time period;
an alert generator for monitoring the reporting table and generating alerts based on criteria related to the accumulated data in the reporting table;
a plurality of inventory management computing devices in the one or more retail stores for generating the transactional data and transmitting the transactional data to the server; and
a plurality of electronic devices configured to receive the alerts and adapted to transmit a response to the alert, the response indicative of conditions of items on shelf space in a store.

20. The method of claim 19, wherein the conditions include out-of-stock conditions, missing sign conditions, blocked shelf conditions and product-to-the-back-of-the-shelf conditions.
